(19) United States
(12) Patent Application Publication
(10) Pub. No.: US 2004/0024783 A1
(43) Pub. Date: Feb. 5, 2004

(54) System and method for managing measurement apparatuses

(76) Inventor: Chih-Kuang Chang, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/330,650

(22) Filed: Dec. 27, 2002

(30) Foreign Application Priority Data
Aug. 1, 2002 (TW) 091117349

(51) Int. Cl. G06F 7/00

(52) U.S. Cl. 707/104.1

(57) ABSTRACT

A system for managing measurement apparatuses includes a database server (20), an application server (30), and a plurality of client computers (50) for accessing the application server via a network (40). The database server is for processing data on measurement apparatuses, and includes a database (10) for storing the data on measurement apparatuses. The application server includes: a data maintenance module (310) for adding, modifying, and querying data on measurement apparatuses and operators; a management data maintenance module (330) for adding, modifying and querying management data on measurement apparatuses; and a sheet filling and querying module (350) for filling in various application sheets, and for querying whether relevant managers have signed the application sheets. Users at the client computers can add, modify and query the data on the measurement apparatuses in the database. Users can also apply for calibration of the measurement apparatuses via the system.

### BACKGROUND OF THE INVENTION

1. Field of the Invention The present invention relates to systems and methods for managing measurement apparatuses, and particularly to a system and method for managing data on measurement apparatuses, and for applying for calibration of measurement apparatuses.

2. Background of the Invention In a large manufacturing enterprise, it is difficult to manage production equipment efficiently, especially measurement apparatuses. The number of measurement apparatuses may be large, and each department of the enterprise may individually purchase various measurement apparatuses. This can make centralized management of the measurement apparatuses of the enterprise problematic. Conventional measurement apparatus management systems employ paper files for recording and transferring information on measurement apparatuses. When an enterprise has numerous measurement apparatuses, paper file systems become cumbersome, cause confusion, and are prone to error when documents are lost.

Computer methods hare been developed for managing measurement apparatuses. China Patent No. 92111977 discloses a system for managing measurement apparatuses with barcodes. The system employs a barcode scanner, a decoder, a computer, a printer, and a keyboard, which are linked with a cable. The keyboard or the scanner inputs information into an information recording card, the information including many barcodes. The decoder decodes the input information, and transfers the information to the computer for storing. The printer prints the information according to demand. The system provides convenient management of information on measurement apparatuses. However, if an enterprise has many departments located at different sites, the system cannot provide adequate management of the measurement apparatuses located at the different sites.

### SUMMARY OF THE INVENTION

Accordingly, an object of the present invention is to provide a system and method for conveniently adding, modifying, and querying data on measurement apparatuses.

Another object of the present invention is to provide a system and method for conveniently managing measurement apparatuses and applying for calibration of measurement apparatuses.

In order to accomplish the above-mentioned objects, the present invention provides a system and method for managing measurement apparatuses. A preferred embodiment of the system comprises a database server, an application server, and a plurality of client computers for accessing the application server via a network. The database server is for processing data on measurement apparatuses, and comprises a database for storing the data on measurement apparatuses. The application server comprises: a data maintenance module for adding, modifying and querying data on measurement apparatuses and operators; a management data maintenance module for adding, modifying and querying management data on measurement apparatuses; and a sheet filling and querying module for filling in various application sheets, and for querying whether relevant managers have signed the application sheets. Users at the client computers can add, modify and query the data on the measurement apparatuses in the database. Users can also apply for calibration of the measurement apparatuses via the system.

A preferred embodiment of the method comprises the steps of: (i) logging in a measurement apparatus management system; (ii) querying management data on a measurement apparatus; (iii) determining whether the queried management data on the measurement apparatus exist; (iv) determining whether the measurement apparatus has been calibrated if the queried management data exist; and (v) applying for calibration of the measurement apparatus if the measurement apparatus has not been calibrated.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware infrastructure of a measurement apparatus management system in accordance with a preferred embodiment of the present invention;

FIG. 2 is a schematic diagram of functional infrastructure of an application server of the system of FIG. 1;

FIG. 3 illustrates an exemplary calibration application sheet in accordance with the present invention;

FIG. 4 is a flow chart of managing a measurement apparatus in accordance with a preferred embodiment of the present invention; and

FIG. 5 is a flow chart of applying for calibration of a measurement apparatus in accordance with the preferred embodiment of the present invention.

### DETAILED DESCRIPTION OF PREFERRED EMBODIMENTS OF THE INVENTION

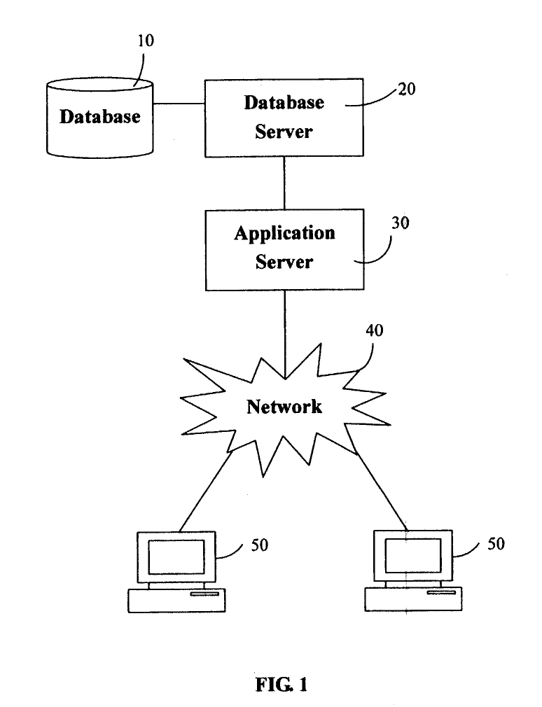

FIG. 1 is a schematic diagram of hardware infrastructure of a measurement apparatus management system in accordance with a preferred embodiment of the present invention. The measurement apparatus management system is based on a Lotus Notes platform such as Lotus Notes R4.6, and comprises a database server 20, an application server 30 and a plurality of client computers 50. The client computers 50 are linked to the application server 30 via a network 40. The database server 20 comprises a database 10 for storing data on measurement apparatuses, such as calibration reports on measurement apparatuses. In the preferred embodiment of the present invention, the database 10 is a single database. Alternatively, the database 10 may be a combination of a plurality of databases. The database server 20 is used for processing the data on measurement apparatuses; for example, storing the data on measurement apparatuses in the database 10, and retrieving the data on measurement apparatuses from the database 10. The application server 30 provides user functions of querying, modifying, and adding to data on the measurement apparatuses. The client computers 50 are located at various departments of an enterprise. Each client computer 50 is configured with the Lotus Notes platform such as Lotus Notes R4.6.

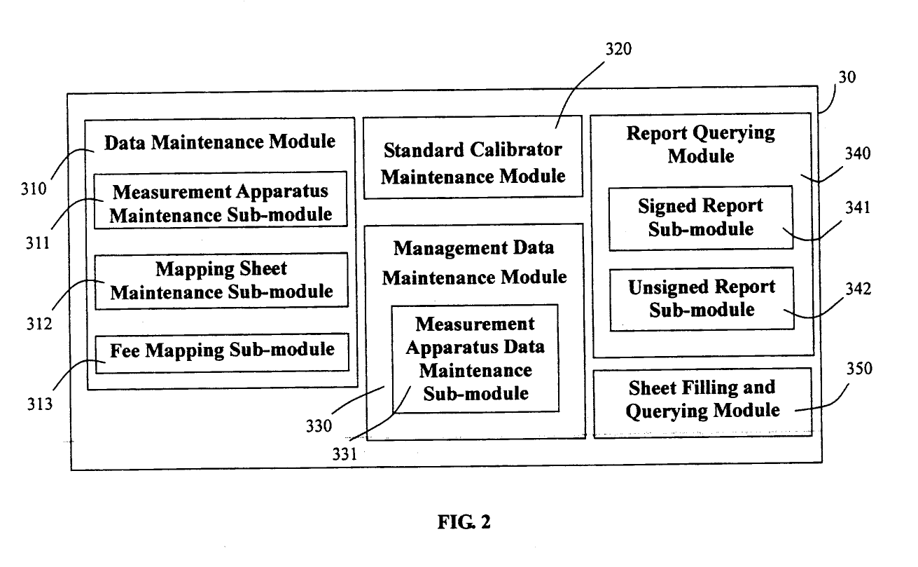

FIG. 2 is a schematic diagram of functional infrastructure of the application server 30. The application server 30 comprises a data maintenance module 310, a standard calibrator maintenance module 320, a management data maintenance module 330, a report querying module 340, and a sheet filling and querying module 350. By employing the above-mentioned modules, users can add, modify, and query data on measurement apparatuses, and can send various reports on measurement apparatuses via e-mail to relevant managers for checking and approval.

The data maintenance module 310 is used for adding, modifying, and querying basic data on measurement apparatuses and operators. The basic data comprise specifications of the measurement apparatuses and authorities of the operators, all of which are stored in the database 10. The data maintenance module 310 comprises a measurement apparatus maintenance sub-module 311, a mapping sheet maintenance sub-module 312, and a fee mapping sub-module 313.

The measurement apparatus maintenance sub-module 311 is used for adding and querying data on measurement apparatuses. The data comprise management number, name, specification, and calibration program of each measurement apparatus. By referring to the data on measurement apparatuses, a user can select a most suitable measurement apparatus for measuring an object.

The mapping sheet maintenance sub-module 312 is used for adding, querying, and modifying data in a department/operator mapping sheet. Based on the department/operator mapping sheet, the measurement apparatus management system defines authorities of various users in different departments of the enterprise.

The fee mapping sub-module 313 is used for adding, modifying and querying data on fees for calibrating measurement apparatuses. The fees for calibrating measurement apparatus are classified according to a degree of urgency of calibration of the measurement apparatus. When a user applies for calibration of a measurement apparatus, and selects “normal” or “urgent” in an urgency degree column in a calibration application sheet, the fee mapping sub-module 313 automatically calculates a fee for the calibration.

The standard calibrator maintenance module 320 is used for adding, modifying and querying data on standard calibrators in the database 10. Standard calibrators are apparatuses used for calibrating measurement apparatuses according to national or international standards.

The management data maintenance module 330 is used for adding, modifying and querying management data on measurement apparatuses that are stored in the database 10. The management data maintenance module 330 provides functions of adding data, querying based on date, querying based on department, querying measurement apparatuses to be calibrated, and so on. The function of adding data is used for adding management data on measurement apparatuses; especially for adding management numbers of measurement apparatuses, the management numbers being used for identifying respective measurement apparatuses. In addition to the management numbers, the management data comprise purchasing dates and calibration cycles. The function of querying based on department is used for querying data on measurement apparatuses used by various departments. The function of querying measurement apparatuses to be calibrated is used for querying measurement apparatuses that are to be calibrated in the near future; for example, in several days. The management data maintenance module 330 comprises a measurement apparatus data maintenance sub-module 331, which is used for querying and modifying data on calibration of measurement apparatuses and data on transfer of measurement apparatuses, and for changing calibration cycles of measurement apparatuses. The data on calibration of measurement apparatuses comprise calibration date, calibrated item, and calibrating person. The data on transfer of measurement apparatuses comprise name of a department receiving a measurement apparatus, and identity of a person in the department who is in charge of the measurement apparatus.

The report querying module 340 is used for querying calibration reports stored in the database 10, and comprises a signed report sub-module 341 and an unsigned report sub-module 342. The signed report sub-module 341 is used for storing calibration reports that have been approved and signed by relevant managers. In the preferred embodiment of the present invention, nobody has authority to modify reports in the signed calibration report sub-module 341. The unsigned report sub-module 342 is used for storing calibration reports that have not been signed by managers. A calibrating operator can modify calibration reports stored in the unsigned report sub-module 342. A manager can check and sign reports using the unsigned report sub-module 342. Such reports are then stored in the signed report sub-module 341.

The sheet filling and querying module 350 is used for filling in various application sheets, and for querying whether relevant managers have signed the application sheets. The application sheets comprise calibration application sheets, transfer application sheets, and management number application sheets.

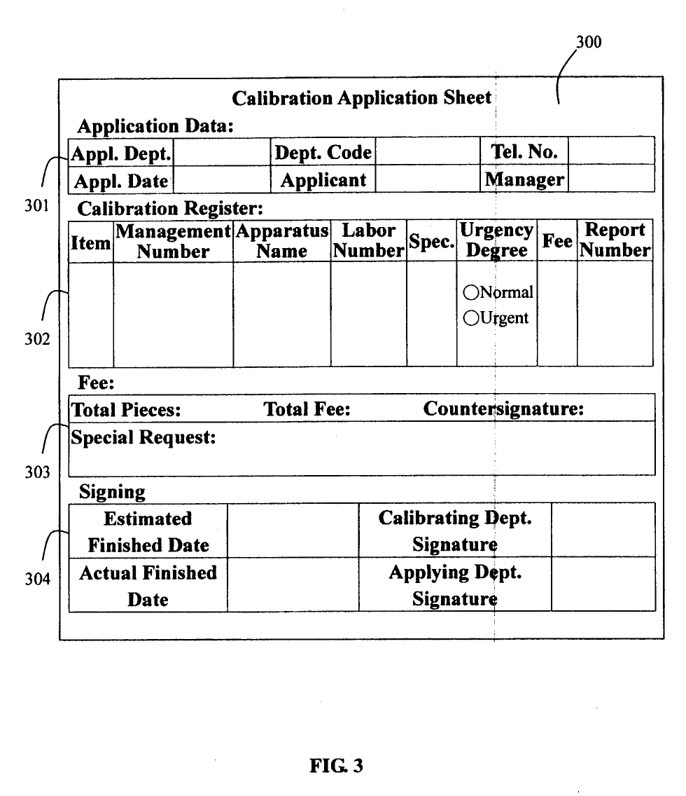

FIG. 3 illustrates an exemplary calibration application sheet 300. In the preferred embodiment of the present invention, the calibration application sheet 300 comprises an application data tabulation 301, a calibration register tabulation 302, a fee tabulation 303, and a signing tabulation 304. The application data tabulation 301 records an applying department, a department code, a telephone number of the applying department, an application date, an applicant, and a manager of the applying department. The calibration register tabulation 302 records a calibration item, a management number of a calibrated measurement apparatus, a measurement apparatus name, a labor number of an operator calibrating the measurement apparatus, a specification of the measurement apparatus, an urgency degree, a fee, and a report number. The fee tabulation 303 records a total number of pieces of calibrated measurement apparatuses, a total fee, a countersignature, and a special request. The signing tabulation 304 records an estimated finished date, an actual finished date, a calibrating department signature, and an applying department signature.

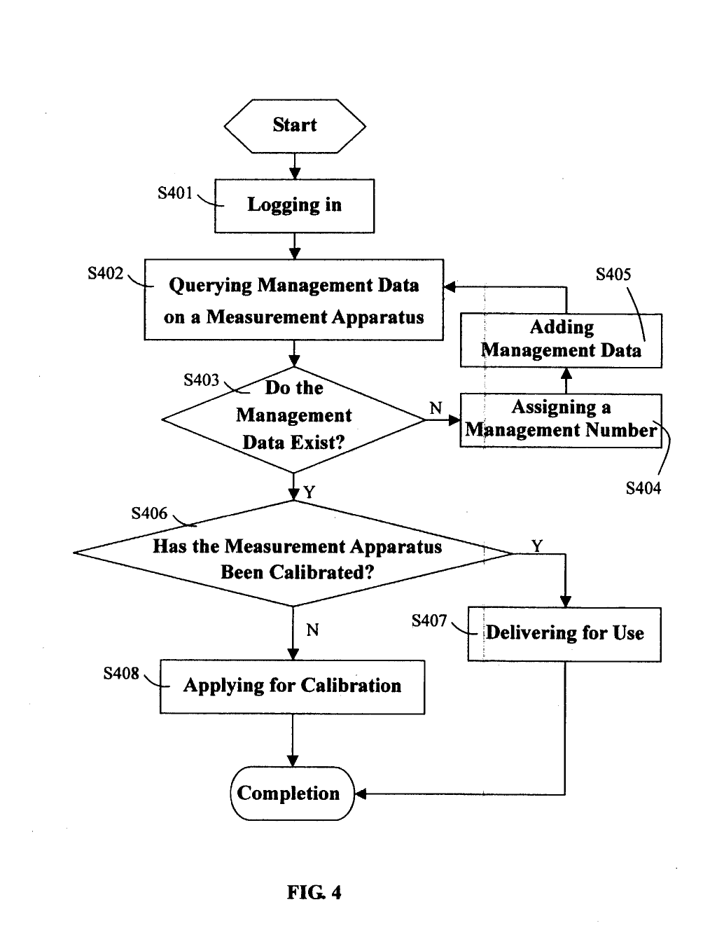

FIG. 4 is a flow chart of managing measurement apparatuses in accordance with a preferred embodiment of the present invention. At step S401, a user logs in the measurement apparatus management system via the Lotus Notes platform of one client computer 50. The user can operate within his/her authority, as defined for him/her based on the department/operator mapping sheet. At step S402, the user queries management data on a measurement apparatus by employing the management data maintenance module 330. At step S403, the management data maintenance module 330 determines whether the queried management data exist. If the queried management data exist, the procedure proceeds directly to step S406 described below. If the queried management data do not exist, the user fills in a management number application sheet. The unsigned report sub-module 342 stores the management number application sheet. After relevant managers sign the management number application sheet, at step S404, the user assigns a management number for the measurement apparatus. At step S405, the user adds management data on the measurement apparatus by employing the management data maintenance module 330. Added management data are stored in the database 10, whereupon the procedure returns to step S402. At step S406, the measurement apparatus management system determines whether the measurement apparatus has been calibrated. If the measurement apparatus has been calibrated, at step S407, the measurement apparatus is delivered for use directly. If the measurement apparatus has not been calibrated, at step S408, the user fills in a calibration application sheet to apply for calibration.

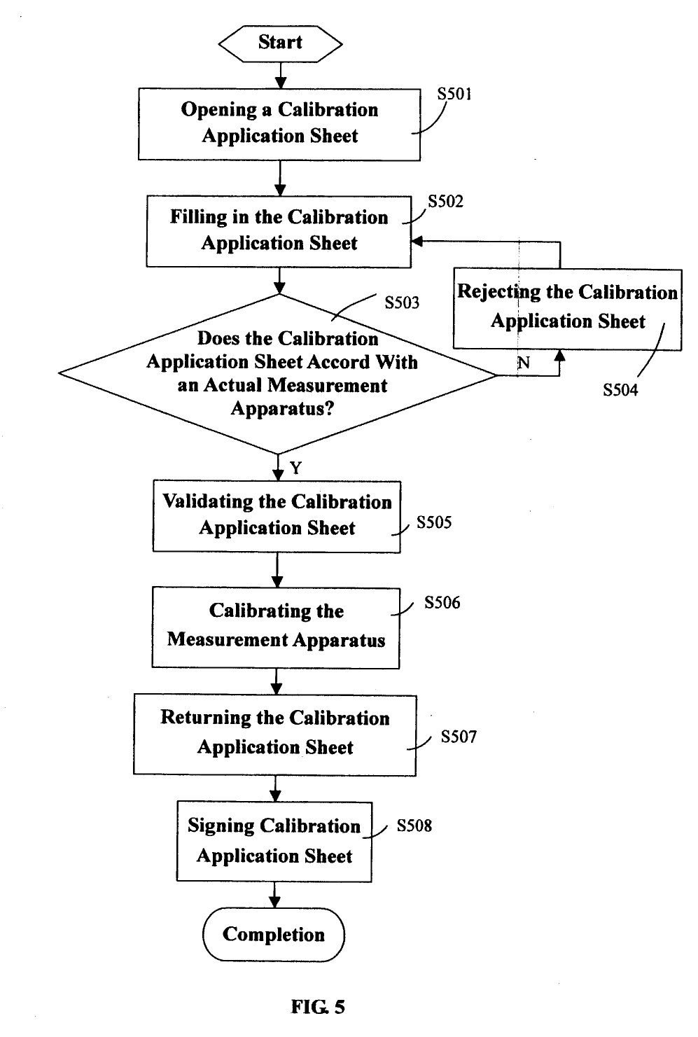

FIG. 5 is a flow chart of applying for calibration of a measurement apparatus in accordance with the preferred embodiment of the present invention. At step S501, a user in an applying department opens a calibration application sheet in the Lotus Notes platform of one client computer 50. An example of a calibration application sheet is shown in FIG. 3. At step S502, the user fills in the calibration application sheet, and sends it to a calibration department. At step S503, an operator in the calibration department checks whether the calibration application sheet accords with an actual measurement apparatus. If the calibration application sheet does not accord with the actual measurement apparatus, at step S504, the operator rejects the calibration application sheet, and the procedure returns to step S502. If and when the calibration application sheet accords with the actual measurement apparatus, at step S505, the operator validates the calibration application sheet. At step S506, the measurement apparatus is calibrated. At step S507, the operator returns the calibration application sheet to the user. At step S508, the user signs the calibration application sheet. The measurement apparatus management system then stores the signed calibration application sheet in the database 10.

While the present invention has been described above, it should be understood that it has been presented by way of example only and not by way of limitation. Thus the breadth and scope of the present invention should not be limited by the above-described exemplary embodiments, but should be defined only in accordance with the following claims and their equivalents.

What is claimed is:

1. A system for managing measurement apparatuses, the system comprising:
a database server for processing data on measurement apparatuses, the database server comprising a database for storing data on measurement apparatuses;
an application server, comprising:
a data maintenance module for adding, modifying and querying data on measurement apparatuses and operators;
a management data maintenance module for adding, modifying and querying management data on measurement apparatuses; and
a sheet filling and querying module for filling in various application sheets, and for querying whether relevant managers have signed the application sheets; and
at least one client computer for accessing the application server.

2. The system as claimed in claim 1, wherein the application server further comprises a standard calibrator maintenance module for adding, modifying and querying data on standard calibrators.

3. The system as claimed in claim 1, wherein the application server further comprises a report querying module for querying calibration reports in the database of the database server.

4. The system as claimed in claim 1, wherein the data maintenance module further comprises a fee mapping sub-module for adding, modifying and querying data on fees for calibrating measurement apparatuses.

5. The system as claimed in claim 1, wherein the management data maintenance module comprises a measurement apparatus data maintenance sub-module for querying and modifying data on calibration of measurement apparatuses and data on transfer of measurement apparatuses, and for changing calibration cycles of measurement apparatuses.

6. The system as claimed in claim 1, wherein the application sheets comprise calibration application sheets.

7. A method for managing measurement apparatuses, the method comprising the steps of:
providing a database server for processing data on measurement apparatuses, the database server comprising a database for storing data on measurement apparatuses;
providing an application server, the application server comprising:
a data maintenance module for adding, modifying and querying data on measurement apparatuses and operators;
a management data maintenance module for adding, modifying and querying management data on measurement apparatuses; and
a sheet filling and querying module for filling in various application sheets, and for querying whether relevant managers have signed the application sheets; and
providing at least one client computer for accessing the application server.

8. The method as claimed in claim 7, wherein the application server further comprises a standard calibrator maintenance module for adding, modifying and querying data on standard calibrators.

9. The method as claimed in claim 7, wherein the application server further comprises a report querying module for querying calibration reports.

10. The method as claimed in claim 7, wherein the data maintenance module further comprises a fee mapping sub-module for adding, modifying and querying data on fees for calibrating measurement apparatuses.

11. The method as claimed in claim 7, wherein the management data maintenance module comprises a measurement apparatus data maintenance sub-module for querying and modifying data on calibration of measurement apparatuses and data on transfer of measurement apparatuses, and for changing calibration cycles of measurement apparatuses.

12. A method for managing measurement apparatuses, the method comprising the steps of:
(a) logging in a measurement apparatus management system;
(b) querying management data on a measurement apparatus;
(c) determining whether the queried management data on the measurement apparatus exist;
(d) determining whether the measurement apparatus has been calibrated if the queried management data exist; and
(e) applying for calibration of the measurement apparatus if the measurement apparatus has not been calibrated.

13. The method as claimed in claim 12, wherein step (d) further comprises the steps of:
(d1) assigning a management number for the measurement apparatus if the queried management data do not exist; and
(d2) adding management data on the measurement apparatus.

14. The method as claimed in claim 12, further comprising the step of: delivering the measurement apparatus for use if the measurement apparatus has been calibrated.

15. The method as claimed in claim 12, wherein step (e) further comprises the steps of:
(e1) filling in and sending a calibration application sheet to a calibration department;
(e2) checking whether the calibration application sheet accords with the measurement apparatus;
(e3) validating the calibration application sheet if the calibration application sheet accords with the measurement apparatus; and
(e4) calibrating the measurement apparatus.

16. The method as claimed in claim 15, wherein step (e3) further comprises the step of:
rejecting the calibration application sheet if the calibration application sheet does not accord with the measurement apparatus.

17. The method as claimed in claim 15, further comprising the step of:
returning and signing the calibration application sheet after calibrating the measurement apparatus.

18. The method as claimed in claim 12, wherein the management data are queried, added or modified by different authorities.
